(19) United States
(12) Patent Application Publication
(10) Pub. No.: US 2002/0010675 A1
(43) Pub. Date: Jan. 24, 2002

(54) System and method for processing a payment transaction during auctioning over a data network

(76) Inventor: Gero Offer, Gilching (DE)

Correspondence Address: Bell, Boyd & Lloyd LLC, P.O. Box 1135, Chicago, IL, 60690, US

(21) Appl. No.: 09/880,387

(22) Filed: Jun. 13, 2001

(30) Foreign Application Priority Data
Jun. 13, 2000 (DE) 10029066.3

(51) Int. Cl. G06F 17/60

(52) U.S. Cl. 705/37; 705/40

(57) ABSTRACT

A system and method for processing a payment transaction during auctioning over an IP network, having an auction server and a payment processing device coupled thereto, wherein the payment processing device includes a credit memory, and a comparator unit for comparing bid data with the credit data for the bidders and for automatically outputting an authorization signal to a controller in the auction server in order to ascertain the bidders authorized to participate as the result of the comparison.

### BACKGROUND OF THE INVENTION

1. Field of the Invention

The present invention relates to both a system and method for processing a payment transaction during auctioning over a data network, in particular an IP network, wherein bid data and credit data are compared for bit authorization purposes.

2. Description of the Prior Art

A considerable number of auction proceedings are still carried out via public auctions, and the payment transactions are processed using the traditional banking channels.

Recently, the Internet has become more and more important, not only as a purchase source for trade in software, books, travel, etc., but also as an opportunity to take part online in auctions throughout the world. Auction proceedings on the Internet are held via auction servers. The payment transactions for such auction proceedings continue to be processed using the conventional banking processes.

There is, thus, the risk that tendered bids are not covered, which entails not only a laborious reminder procedure, but also additional costs both for the auction supplier and for the auctioneer.

Even if the auction proceeding has progressed correctly, the auction proceeding could be reversed in a mutual agreement between the supplier and the bidder. If the goods to be auctioned are faulty, the bidder could for his part ask that the transaction be reversed. Such reversal of the auction proceeding entails the risk that the commission to which the auctioneer is entitled will not be paid by the participants.

The present invention is, therefore, directed to a system and a method for secure and uncomplicated processing of a payment transaction during auctioning using a data network.

### SUMMARY OF THE INVENTION

Accordingly, the invention embraces the fundamental concept of providing a payment processing device which is run by a service provider (auctioneer) and is coupled to a known auction server for processing an auction proceeding on the Internet. This allows monitoring and processing not only of the auction proceeding by the auctioneer, but also of the actual payment transaction when a bid has been successfully completed.

The present invention also embraces the concept of allowing participation in such an auction proceeding only by those suppliers and bidders who have started an electronic credit balance with an appropriate minimum credit with an authorized auctioneer, specifically only for the purposes of auctioning. The electronic credit balance can be checked at any time both by the auctioneer and by the bidder, the bidder being given the option of changing the volume of his electronic credit balance not only before, but also during an auction up to the time at which a bid is successfully completed.

Constant checking of the bidder's electronic credit balance and comparison of this data with the respective bid data by a comparator unit results in bidders being excluded from participation in the auction as a result of this comparison, due to a lack of sufficient credit. As such, only valid bids, i.e. only those which are covered by corresponding electronic credit balances, can result in successful completion of the auction proceeding. An additional memory unit, provided in the payment processing device, for storing and blocking this part of the electronic credit balance which corresponds to the level of the highest bid permits a secure and uncomplicated payment transaction, even if bidding is being carried out at two auctions in parallel.

In one advantageous embodiment of the present invention, the auction server has a memory unit which contains a memory area with bidder identification data which is, in principle, not transmitted to the supplier, and hence the bidder is granted anonymity. With this solution, the auction proceeding can take place and the payment transaction can be processed adequately if the bidder deals only under a code number, since the secure payment transaction is ensured by a sufficient electronic credit balance.

In another advantageous embodiment of the present invention, the supplier is firstly connected to his bank and/or credit card institute via an interface of his terminal, and secondly allowed access to the credit memory area using an authentication unit associated with the payment processing device in order to change his/her electronic credit balance after the auction.

In another advantageous embodiment of the present invention, the payment processing device contains upper creditworthiness limits for which the auctioneer guarantees subsequent processing and payment via regular payment channels (banks) instead of the bidders. This is particularly useful for B2B auctions, in which relatively large transactions are concluded with anonymity maintained. Processing and payment are then handled by the auctioneer; i.e., sums of money do not need to be held in the payment processing device.

In addition, in another embodiment of the present invention, the bidder terminal has an interface for connection firstly to the bidder's bank and/or credit card institute and secondly to the credit memory of the payment processing device using an authentication unit. The bidder can, thus, automatically manage his/her electronic credit balance and, during an auction, can use the option to increase the credit balance if need be and to continue to participate in the auction. This solution increases the flexibility of auctioning on the Internet and allows the bidder with a minimum starting credit balance to participate in auction proceedings with relatively high minimum bids.

In accordance with a further embodiment of the present invention, the auctioneer carries no invoice risk by handling the payment channel data, since the commission to which the auctioneer is entitled is automatically credited to his electronic credit balance before the auction proceeding is concluded. This aspect is particularly important if the auction proceeding is reversed, which may be done either as a result of a mutual agreement between the supplier and the bidder or else only by the bidder in the event of faulty goods being delivered.

A payment transaction in auctioning could be processed not only over a data network, but also by virtue of a link between IP network and telecommunication network, in particular a mobile radio network, which increases the flexibility of auctioning.

In this context, the present invention can, in principle, be implemented using any desired terminals which are configured on the basis of an IP network protocol or are able to communicate with an IP network; in particular, with PCs, laptops, or mobile radio terminals with WAP capability. In this case, appropriate gateway servers which set up the connection between the mobile radio network and the IP network will be used to connect mobile radio terminals to the auction server to which the payment processing device is coupled.

The processing devices provided at the auction server are expediently equipped with a watchdog functionality, i.e. they are activated only upon the arrival of a specific minimum bid request signal sent by the supplier, and then perform the appropriate signal and data transmissions.

Additional features and advantages of the present invention are described in, and will be apparent from, the following Detailed Description of the Preferred Embodiments and the Drawings.

### DESCRIPTION OF THE DRAWINGS

FIG. 1 shows a schematic block diagram of the various component parts and lines of communication of the system of the present invention.

### DETAILED DESCRIPTION OF THE PREFERRED EMBODIMENTS

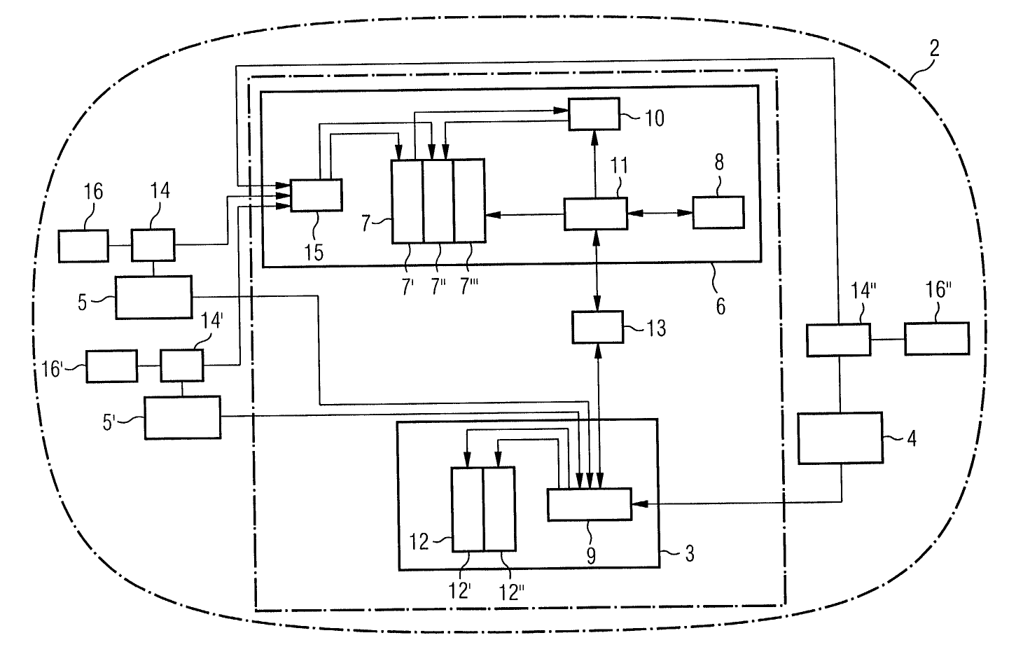

FIG. 1 shows a system 1 for processing an auction proceeding and a corresponding payment transaction over an IP network 2 and also the flow of data from a first terminal 4 associated with the auction supplier via an auction server 3 associated with an authorized auctioneer to second terminals 5, 5′ associated with auction bidders.

The auction server 3, for its part, is connected to a payment processing device 6 via an interface 13 and, in connection with the implementation of the present invention, has the fundamental component of a memory device 12 which includes a bidder memory area 12′, with stored bidder identification data, and a bid data memory area 12″ with bid data. Another fundamental component is a controller 9 which is used to control the processing of the auction proceeding and of the payment transaction.

The payment processing device 6 has an account data memory 7 having a first memory area 7′, a second memory area 7″ and a third memory area 7′″ for storing a respective electronic credit balance for a bidder, for the supplier and for the auctioneer. Another fundamental element of the payment processing device 6 is a control and processing unit 11 which revises the data received from the auction server 3 and the credit data stored in the credit memory 7 and controls the actual payment transaction.

The payment processing device 6 also has a comparator unit 8 which is connected via the control and processing unit 11 firstly to the credit memory 7 and secondly to the controller 9 in the auction server 3, in order to compare current bid data with credit data for the respective bidder. The comparator unit 8 uses the controller 9 to ascertain those bidders who are entitled to participate in the respective auction on the basis of the level of their electronic credit balance, and automatically outputs a corresponding authorization signal.

The payment processing device 6 also has a payment memory unit 10 which is connected to the credit memory 7 via the control and revision unit 11. The payment memory unit 10 is used to store and block a part of the bidder's electronic credit balance which corresponds to the highest bid in an auction proceeding which has been successfully completed for him. This credit balance is transferred to and stored in the memory unit 10 by the control and processing unit 11 accessing the bidder's electronic credit balance contained in the memory area 7′.

The bidder terminals 5, 5′ are respectively connected firstly to the respective bank server 16, 16′ via an interface 14, 14′, and secondly to the memory area 7′ via an authentication unit 15 in the payment processing device 6 for the purpose of crediting and debiting an electronic credit balance. This credit transfer can be performed by the bidder himself/herself before and during the auction.

The supplier terminal 4 is likewise firstly connected to a bank server 16″ via an interface 14″, and secondly to the memory area 7″ via the authentication unit 15 in the payment processing device 6 for the purpose of changing the bidder's electronic credit balance after the auction.

The auction server 3 contains connection devices (not shown) equipped with a watchdog functionality. These are activated only upon the arrival of a specific minimum bid request signal from the supplier terminal 4, and only then perform the appropriate signal and data transmissions. The minimum bid data received in the form of a request signal are transmitted to the memory unit 12 by the controller 9 in order to store the minimum bid data under a transaction number in the bid data memory area 12″.

In addition, the controller 9 accesses the bidder memory area 12″, which contains bidder identification information, of the memory unit 12 in order to transmit the received minimum bid data with the respective transaction number to all bidders registered to participate in the auction by virtue of an electronic credit balance having been set up. The minimum bid data are also transmitted to the comparator unit 8 by the controller 9 via the control unit 11.

That bidder interested in the auction can use his terminal to send an auction registration signal for participation in the respective auction. This auction registration signal contains the transaction number under which the auction object is being traded. This provides the bidders with the opportunity to participate in a number of auctions at the same time. The auction registration signal is transmitted via the controller 9 to the memory area 12′ and is stored there in a participant list.

The identification data for the registered bidders is transmitted to the comparator unit 8 by the controller 9 via the control and revision unit 11 in the payment processing device 6, in the same way as the minimum bid data. The control and revision unit 11 ascertains the current electronic credit balance for each bidder registered to participate in the auction by accessing a respective bidder memory area 7′ of the credit memory 7, and sends it to the comparator unit 8.

The comparator unit 8 compares the received minimum bid data with the current electronic credit balance for each bidder. As the result of this comparison, the comparator unit 8 outputs a preselection signal to the controller 9 for the purposes of confirming or not confirming participation for each individual bidder. This signal is also transmitted to the respective bidder by the controller 9 which, in the event of participation not being confirmed, gives the bidder who is not authorized the opportunity to increase his electronic credit balance in the memory area 7′ by accessing his electronic credit balance at the respective bank institute, and hence to participate in the auction. This opportunity also exists during the auction.

Once the bidders authorized to participate have been ascertained, the controller 9 sends an auction request signal to the bidders, who submit their bids using their terminals 5, 5′. The bid data received by the controller is stored in the bid data memory area 12″ of the memory unit 12, and the current highest bid is transmitted to all the bidders.

Those bidders who bid above the current limit are stored in the participant list in the memory unit 12, and the associated bidder memory areas 7′ of the credit memory 7 are addressed successively, and the stored credit data are read out to the comparator unit 8. The comparator unit 8 compares the current bid data with the current electronic credit balance for the bidder registered for further participation, blocks (reserves) the amount bid for the highest bidder, so that a guaranteed payment is also ensured in the case of parallel auctions, and sends a selection signal to the controller 9 for the purpose of confirming or not confirming participation of the respective bidder. The controller 9 transmits this information to the bidders who, if appropriate, again have the opportunity to increase their electronic credit balances for participating in the auction by accessing their bank credit balances. In this case, they send a correction request signal to the auctioneer which initiates another check on the credit balance.

If a bid is successful, the appropriate part of the respective bidder's electronic credit balance is transferred to the memory unit 10 via the control and revision unit 11 by accessing an electronic credit balance in the memory area 7′ of the credit memory 7, and is blocked under the respective transaction number. This ends the transaction and secures the payment transaction.

If the auction object is delivered successfully, the stored part of the bidder's electronic credit balance is released upon entry of the transaction number and PIN and is transferred via the control and revision unit 11 to that memory area 7′ in which the supplier has an electronic credit balance.

If the auction proceeding is reversed on account of a faulty auction object or by mutual agreement between the bidder and the supplier, the stored amount is likewise released, specifically for transfer back to the appropriate bidder's credit memory area 7′.

The commission to which the auctioneer is entitled is secured by virtue of part of the supplier's electronic credit balance being transferred to the auctioneer's memory area 7′″ by using the control and revision unit 11 in the payment processing device 6 to access the memory area 7″ of the credit memory 7 after receipt of the specific minimum bid request signal from the supplier terminal 4.

Alternatively, a percentage, stipulated by the auctioneer, of the successful bid is transferred from the memory area 7′ to the memory area 7′″

In another exemplary embodiment (not shown) of the present invention, the auction proceeding and the payment transaction can be processed as a result of the link between IP network and a mobile radio network. In this context, the present invention may be implemented particularly advantageously using mobile terminals with WAP capability. However, the proposed system also increases the reliability of auctions of traditional type in which telephone bids are taken.

Although the present invention has been described with reference to specific embodiments, those of skill in the art will recognize that changes may be made thereto without departing from the spirit and scope of the invention as set forth in the hereafter appended claims.

I claim as my invention:

1. An system for processing a payment transaction during auctioning over an IP data network, comprising:
an auction server for a network connection between a first terminal associated with an auction supplier and a plurality of second terminals respectively associated with a plurality of auction bidders, the auction server including a controller;
a payment processing device coupled to the auction server;
a credit memory as part of the payment processing device, the credit memory having a plurality of first credit memory areas for storing electronic credit balances for the plurality of auction bidders; and
a comparator unit as part of the payment processing device, the comparator unit connected to both the controller of the auction server and the plurality of first credit memory areas via a control and processing unit, the comparator unit comparing current bid data with respective credit data for the plurality of auction bidders and automatically outputting an authorization signal to the controller in the auction server in order to ascertain, as a result of the comparison, which of the plurality of auction bidders are authorized to participate.

2. A system for processing a payment transaction during auctioning over an IP data network as claimed in claim 1, further comprising:
a payment memory unit as part of the payment processing device, the payment memory unit connected to the credit memory for storing and blocking a part of an electronic credit balance of a successful bidder which corresponds to a highest bid.

3. A system for processing a payment transaction during auctioning over an IP data network as claimed in claim 1, further comprising:
a separately addressable second credit memory area as part of the credit memory, the second credit memory area for storing an electronic credit balance for the auction supplier; and
a separately addressable third memory area as part of the credit memory, the third memory area for storing an electronic credit balance associated with an auctioneer.

4. A system for processing a payment transaction during auctioning over an IP data network as claimed in claim 3, wherein the control and processing unit has capability to electronically credit the electronic credit balance of the auction supplier in the second credit memory area by accessing the electronic credit balances for the plurality of auction bidders in one of the first credit memory areas, and also to internally electronically credit the electronic credit balance for the auctioneer in the third credit memory area by accessing the electronic credit balance of the supplier.

5. A system for processing a payment transaction during auctioning over an IP data network as claimed in claim 1, further comprising:
a memory unit as part of the auction server, the memory unit including a bidder memory area containing bidder identification data and a bid data memory area containing stored bid data.

6. A system for processing a payment transaction during auctioning over an IP data network as claimed in claim 1, further comprising:
a plurality of interfaces respectively associated with the plurality of bidder terminals for connection to a plurality of respective bank servers and for connection, via an authentication unit in the payment processing device, to the credit memory in the payment processing device for crediting and debiting a respective electronic credit balance.

7. A method for processing a payment transaction during auctioning over an IP data network, the method comprising the steps of:
storing a plurality of electronic credit balances for a respective plurality of auction bidders in a credit memory of a payment processing device connected to an auction server in the IP network;
sending, via one of a supplier terminal and an auctioneer terminal, minimum bid data to the auction server;
storing the minimum bid data under a transaction number in a memory unit of the auction server;
transmitting the stored minimum bid data with the transaction number to both a plurality of bidder terminals and, via a control and processing unit of the payment processing device, a comparator unit in the payment processing device;
receiving and comparing the minimum bid data, in the comparator unit, with respective credit data for the plurality of auction bidders by accessing first credit memory areas of the credit memory;
comparing, via the comparator unit, current bid data and the respective credit data for the plurality of auction bidders at each auction stage; and
outputting, as a result of the comparison, a selection signal to a controller in the auction server in order to ascertain which of the plurality of auction bidders are authorized to participate.

8. A method for processing a payment transaction during auctioning over an IP data network as claimed in claim 7, the method further comprising the step of:
storing and blocking, in the event of a successful bid, part of an electronic credit balance of a successful bidder under a respective transaction number and a payment memory unit in the payment processing device.

9. A method for processing a payment transaction during auctioning over an IP data network as claimed in claim 7, the method further comprising the step of:
storing, via the credit memory in the payment processing device, electronic credit balances both for the auction supplier in the second credit memory area and for the auctioneer in a third credit memory area.

10. A method for processing a payment transaction during auctioning over an IP data network as claimed in claim 7, the method further comprising the step of:
accessing by the plurality of auction bidders, via an authentication unit in the payment processing device, the first credit memory areas and changing respective electronic credit balances before and during an auction.

11. A method for processing a payment transaction during auctioning over an IP data network as claimed in claim 9, the method further comprising the steps of:
releasing, once an auction object has been delivered, the part of the electronic credit balance of the successful bidder which is blocked in the memory unit by at least one of the successful bidder and the supplier entering at least one of the transaction number and a PIN; and
crediting electronically, via the control and processing unit in the payment processing device, the electronic credit balance of the supplier in the second credit memory area.

12. A method for processing a payment transaction during auctioning over an IP data network as claimed in claim 9, the method further comprising the step of:
lifting by the supplier, if an auction proceeding is reversed, the block on the part of the electronic credit balance of the successful bidder which is to be paid by entering the transaction number and a PIN.

13. A method for processing a payment transaction during auctioning over an IP data network as claimed in claim 9, the method further comprising the step of:
crediting electronically the electronic credit balance for the auctioneer in the third credit memory area by accessing the electronic credit balance for the supplier in the second credit memory area.

14. A method for processing a payment transaction during auctioning over an IP data network as claimed in claim 7, the method further comprising the step of:
accessing the credit memory area by the supplier, via the authentication unit in the payment processing device, to change the electronic credit balance of the supplier after the auction.
